(19) United States
(12) Patent Application Publication
(10) Pub. No.: US 2024/0344896 A1
(43) Pub. Date: Oct. 17, 2024

(54) SYSTEM AND METHOD FOR COMBINED TEMPERATURE SENSING AND HEATING

(71) Applicant: MYANT INC., Toronto (CA)

(72) Inventor: Godfried Gysbrecht EDELMAN, Toronto (CA)

(21) Appl. No.: 18/682,783

(22) PCT Filed: Aug. 9, 2022
(86) PCT No.: PCT/CA2022/051217

§ 371 Date: Feb. 9, 2024

Related U.S. Application Data
(60) Provisional application No. 63/231,405, filed on Aug. 10, 2021.

(51) Int. Cl. G01K 7/16

(52) U.S. Cl. CPC G01K 7/16

(57) ABSTRACT

There is provided systems and methods for using a fibre-based temperature sensor and heater integrated into a base fabric layer for a textile. A first portion of conductive fibre may be heated for a first time duration using a power source. The power source may be disconnected from the first portion for a second time duration. Electrical resistance of the first portion may be measured while disconnected from the power source. The temperature of an area adjacent to the first portion may be determined based on the electrical resistance.

### CROSS-REFERENCE TO RELATED APPLICATIONS

This claims priority to U.S. Provisional Patent Application No. 63/231,405, filed on Aug. 10, 2021, the entire contents of which are hereby incorporated by reference in their entirety.

### FIELD

This relates generally to smart textiles and associated components found therein.

### BACKGROUND

Smart technology textiles offer numerous advantages and benefits, as well as numerous associated challenges with implementation. For example, protection of conductive fibres present in smart technology textiles can be problematic due to electrical insulation, thermal protection, as well as strain and stretch protection. It is recognised that conductive fibres present in the interlaced set of fibres of a textile body require shielding from inadvertent contact from adjacent conductive fibres as well as electrically conductive objects (e.g. metallic objects handled by a wearer of the textile) external to the textile. In particular, conductive fibres (e.g. metal wire) need to be selectively shielded from shorts, strain, stretch and direct contact with elements external to the textile.

In particular, it is desirable to reduce costs associated with the manufacture and assembly of smart textiles, especially in which the conductive fibres are interlaced directly into the body of the textile as the set of textile fibres is being manufactured, e.g. also referred to as interlaced (e.g. knitted) on demand. One way of reducing such costs is to efficiently use components in creative ways.

Some smart textiles may use components configured to detect temperature, as well as components which may heat an area of the smart textile. The protection of conductive fibres in textiles is particularly important, as “smart” garments may utilize multiple paths of conductive fibres to carry power and signals to and from different locations on the textile body of the garment to sense temperature and provide heating.

It would be desirable to reduce costs associated with manufacture and assembly of smart textiles and to make efficient use of components contained within smart textiles.

### SUMMARY

According to an aspect, there is provided a system for a fibre-based temperature sensor and heater integrated into a base fabric layer for a textile, the system comprising: a first portion of conductive fibre electrically connected to a second portion of conductive fibre; a heating circuit for heating an area adjacent to the first portion of conductive fibre, the heating circuit comprising a power source selectively connected to said second portion of conductive fibre via one or more switching elements; a controller configured to measure an electrical resistivity of the first portion of conductive fibre to determine a temperature associated with an area adjacent to said first portion of conductive fibre, said controller further configured to selectively activate said one or more switching elements to cause said power source to heat said area adjacent to said first section of conductive fibre.

According to another aspect, there is provided a method of using a fibre-based temperature sensor and heater integrated into a base fabric layer for a textile, the method comprising: heating a first portion of conductive fibre for a first time duration using a power source; disconnecting said power source from said first portion of conductive fibre for a second time duration; measuring, during said second time duration, a resistance of said first portion of conductive fibre; determining, based on said resistance, a temperature of an area adjacent to said first portion of conductive fibre.

Other features will become apparent from the drawings in conjunction with the following description.

### BRIEF DESCRIPTION OF DRAWINGS

In the figures which illustrate example embodiments,

FIG. 1 is a system view of example garments for wearing on a body of a wearer;

FIG. 2 is a block diagram of components of an example textile computing system;

FIG. 3 shows an embodiment of a fibre based temperature sensor integrated directly into the interlacing of the fibres making up the body of the textile computing platform shown in FIG. 2;

FIG. 4 shows a further example application of the fibre based temperature sensor of FIG. 3;

FIG. 5 shows a front perspective view of an embodiment of the fibre based temperature sensor of FIG. 3;

FIG. 6 shows a cross sectional view of a further embodiment of the fibre based temperature sensor of FIG. 3;

FIG. 7 shows a cross sectional view of a further embodiment of the fibre based temperature sensor of FIG. 3;

FIG. 8 shows a cross sectional view of a further embodiment of the fibre based temperature sensor of FIG. 3;

FIG. 9 shows an example technique of interlacing of the fibres of the fibre based temperature sensor connected to fibres in the body of the textile of FIG. 3;

FIG. 10 shows a further example technique of interlacing of fibres for the textile of FIG. 3;

FIG. 11 shows a further example technique of interlacing of the fibres of the fibre based temperature sensor connected to fibres in the body of the textile of FIG. 3;

FIG. 12 is an alternative embodiment of the fibre based temperature sensor of FIG. 3;

FIG. 13 is an example method of manufacturing the fibre based temperature sensor of FIG. 3;

FIG. 14A is a further embodiment of the fibre based temperature sensor of FIG. 3;

FIG. 14A is an operational example of stretch experienced by the fibre based temperature sensor of FIG. 14A;

FIGS. 15A, 15B, and 15C are further embodiments of the fibre based temperature sensor of FIG. 14A; and

FIGS. 16, 17, 18, 19 are still further embodiments of the fibre based temperature sensor of FIG. 14A; and

FIG. 20 is a block diagram illustrating components of an example fibre-based temperature sensing and heating system.

### DETAILED DESCRIPTION

Some smart textiles may include temperature sensing elements. Some temperature sensing elements may be fibre-based temperature sensors. In terms of fibre-based temperature sensors, the physical length of the conductive fibres which constitute the sensor may be used to measure the temperature of an area adjacent to the temperature sensor. This may be accomplished, for example, by recognizing that there is a relationship between temperature and electrical resistance of the conductive fibres, namely that temperature is proportional to the electrical resistance of the conductive fibres making up the fibre based temperature sensor.

However, a number of factors can influence the electrical resistance of conductive fibres. Such factors may result in the resistance varying for reasons unrelated to temperature. For example, any change in length and/or cross sectional area of the conductive fibres would result in a change in the electrical resistance. As another example, exposure of the fibres to moisture would result in a change in the electrical resistance. This is especially important for conductive yarns, as textiles/garments can be exposed to environmental moisture sources (e.g. humidity) as well as moisture from the user's body directly (e.g. sweat).

Plastic insulation applied to the exterior surface of the wires may work well in non-textile applications. However, in textile/garment applications, plastic coated wires are less suitable due to their relative inflexibility in comparison to other non-conductive fibres making up the textile/garment, as well as the unsightly appearance of plastic coated wires in comparison to other non-conductive fibres making up the textile/garment. As another example, exposure to heat (e.g. body heat of the textile/garment user) can also impact the resistance of the conductive fibres of the temperature sensor.

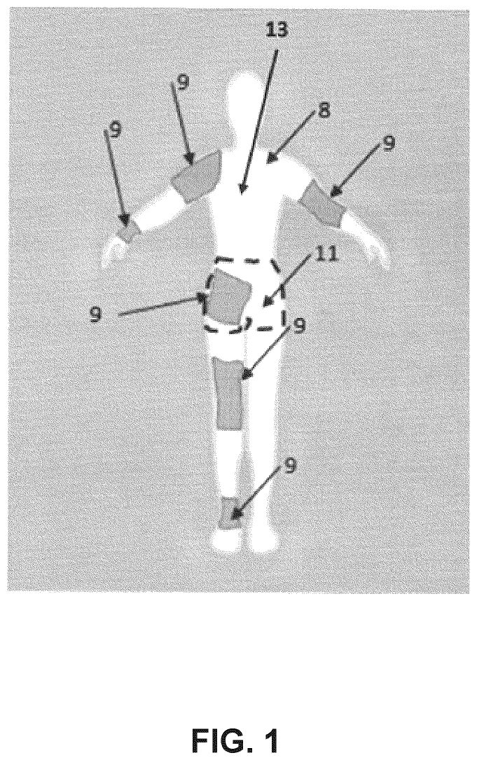

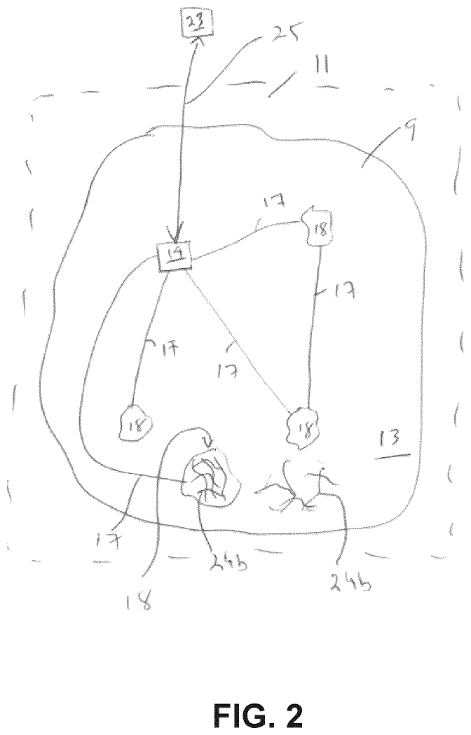

FIG. 1 depicts a body 8 of a wearer for wearing one or more textile based computing platforms 9 positioned about one or more regions (e.g. knee, ankle, elbow, wrist, hip, shoulder, neck, etc.) of the body 8. For the sake of simplicity, textile based computing platforms 9 are also referred to herein as textile computing platforms 9. For example, the textile computing platforms 9 can also be referred to as a wrist sleeve 9, a knee sleeve 9, a shoulder sleeve 9, an ankle sleeve 9, a hip sleeve 9, a neck sleeve 9, etc. Textile computing platform 9 may be incorporated as part of a larger garment 11 (e.g. a pair of briefs 11 as shown in ghosted view for demonstration purposes only). Garment 11 may also be a shirt, pants, body suit, or the like. As such, a fabric/textile body 13 of the garment 11 can be used to position the textile computing platform 9 for selected areas of the body 8. In other words, the textile computing platform 9 may contain a number of textile computing components, e.g. sensors/actuators 18, electronic circuits 17, controller 14—see FIG. 2, which may be incorporated into or otherwise mounted on a fabric/textile body 13 of the garment 11.

The textile computing platform 9 may be incorporated into a textile 9 (e.g. a fabric sheet, a covering, or other fabric structure) that is not worn by the body 8, and instead is positioned adjacent to the body 8. Examples of may include bedsheets, seat coverings (e.g. car seat), and the like.

As depicted in the examples of FIGS. 1 and 2, textile computing platform 9 is integrated with the textile/fabric body 13 (e.g. a plurality of fibres/threads/yarn interlaced as woven and/or knitted, as desired). Textile computing platform 9 may include a controller 14 for sending/receiving signals to one or more sensors/actuators 18 distributed about the body 13. The shape of the sensors/actuators 18 can be elongate (e.g. as a strip extending in a preferred direction) or can extend as a patch in a plurality of directions (e.g. extend side to side and end to end). The signals may be transmitted between the sensors/actuators 18 and the controller 14 via one or more electronic circuits 17 connecting the controller 14 to each of the sensors/actuators 18. It is also recognized that the electronic circuits 17 can also be between individual pairs of the sensors/actuators 18, as desired. As further described below, the sensors/actuators 18 can be textile based (i.e. incorporated via interlacing (e.g. knitting, weaving) as integral to the material structural integrity of the fabric layer of the body 13 (formed as a plurality of interlaced threads of electrically conductive and optionally non-conductive properties)). Further, the electronic circuits 17 (e.g. electrically conductive threads) can also be incorporated/interlaced (e.g. knitting, weaving, etc.) into/with the adjacent fabric layer of the body 13 (also comprising a plurality of interlaced threads/fibres). The controller 14, further described below, can include a network interface (e.g. wireless or wired) for communicating with a computing device 23 (e.g. smart phone, tablet, laptop, desktop, etc.) via a network 25.

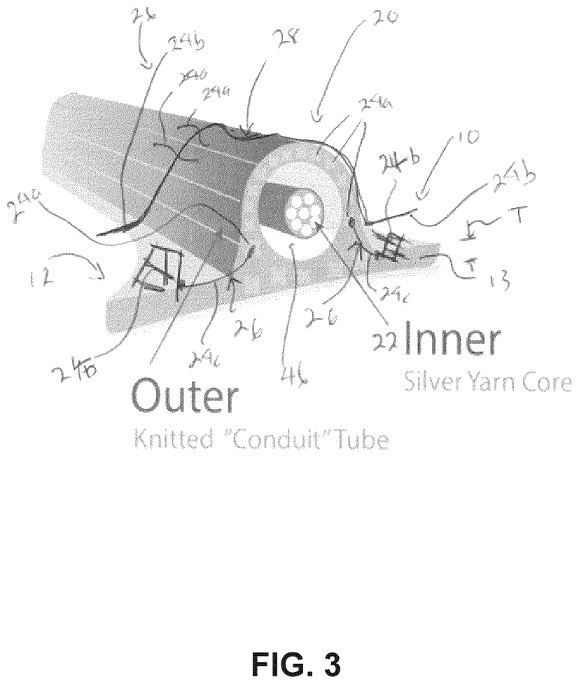

As depicted in FIG. 3, the fabric layer of the body 13 may have a first side 10 and a second side 12, such that the sides 10, 12 are opposed to one another with respect to an intervening insulated conductor 20. Preferably, the side 10 and the side 12 of the fabric layer of the body 13 may be situated in the same plane (e.g. a flat or curved fabric surface of thickness T—uniform or varied) in a composition of the textile computing platform 9 of the garment 11 (see FIG. 2). It is recognised that the sensors/actuators 18 of the textile based computing platform 9 can be formed as integral components of the interlacing of the fibres making up the body 13. The fabric of the body 13 may comprise of interlaced resilient fibres 24b (e.g. stretchable natural and/or synthetic material and/or a combination of stretchable and non-stretchable materials, recognizing that at least some of the fibres comprising the sensors/actuators 18 are electrically conductive).

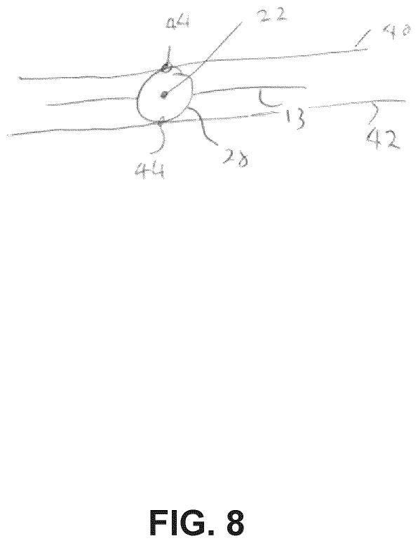

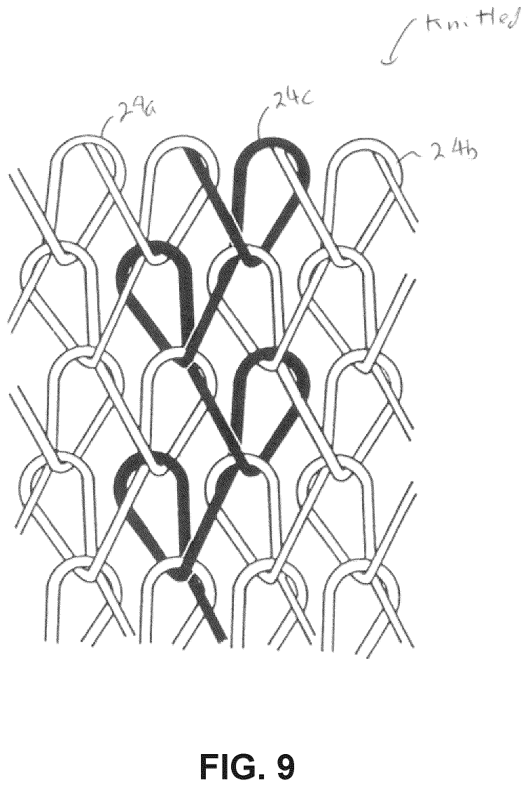

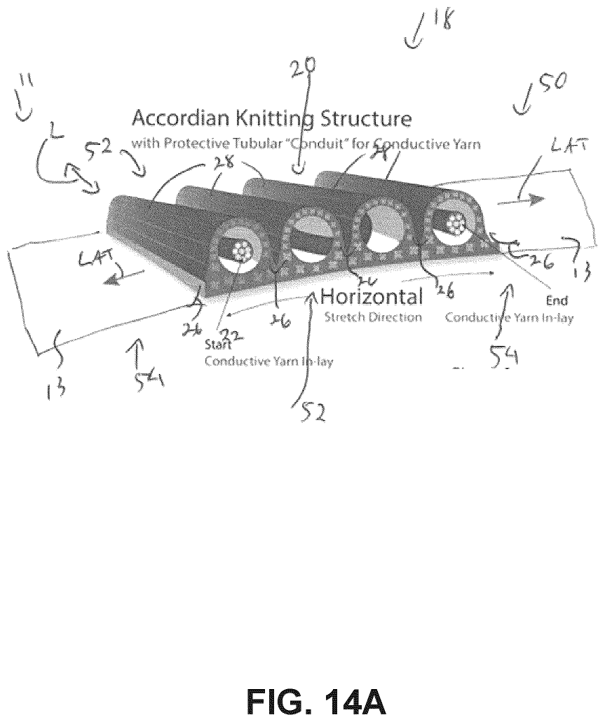

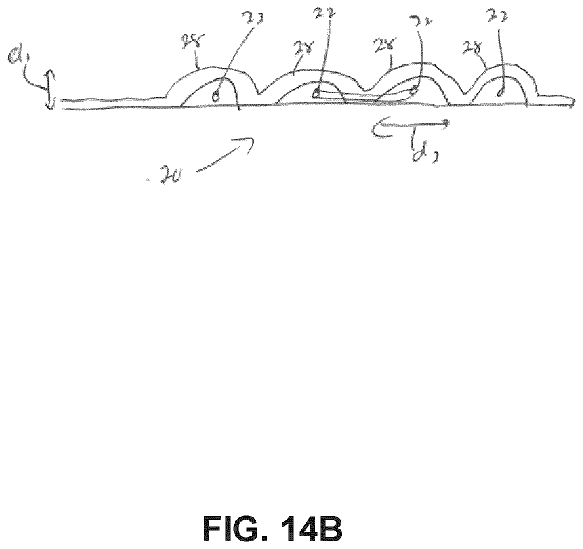

FIGS. 3 and 5-12 show an example wall structure 28 of one insulated conductor 20 for the temperature sensor for clarity/demonstration purposes, for purposes of example only. FIGS. 14A, 14B, 15A, 15B, 15C, 16, 17, 18, 19 show multiple insulated conductors 20 adjacent to one another using the interlacing construction techniques of the wall structures 28 described in FIGS. 3 and 5-13 that are compatible for multiple adjacent wall structures 28 as shown.

Referring to FIG. 3, shown is an example insulated conductor 20 for one or more conductive fibres 22 (e.g. thread(s), yarn(s), etc.). The conductive fibre(s) 22 can be, for example, the electronic circuit 17 as described with reference to FIG. 2. The insulated conductor 20 may comprise a plurality of insulative (i.e. non-conductive) interlaced fibres 24a (e.g. woven, and/or knitted fibres 24a with respect to one another) in a wall structure 28, such that the interlaced fibres 24a are connected 26 with respect to one or more fibres 24b making up the fabric layer of the body 13. The fibres 24a are formed as (e.g. at least a portion of) the wall structure 28 (e.g. tube) surrounding the conductive fibre(s) 22. The fibre(s) 24a can be referred to as wall fibre(s) 24a, the fibre(s) 24b can be referred to as base fibre(s) 24a and any optional individual fibres 24c can be referred to as connection fibre(s) 24c.

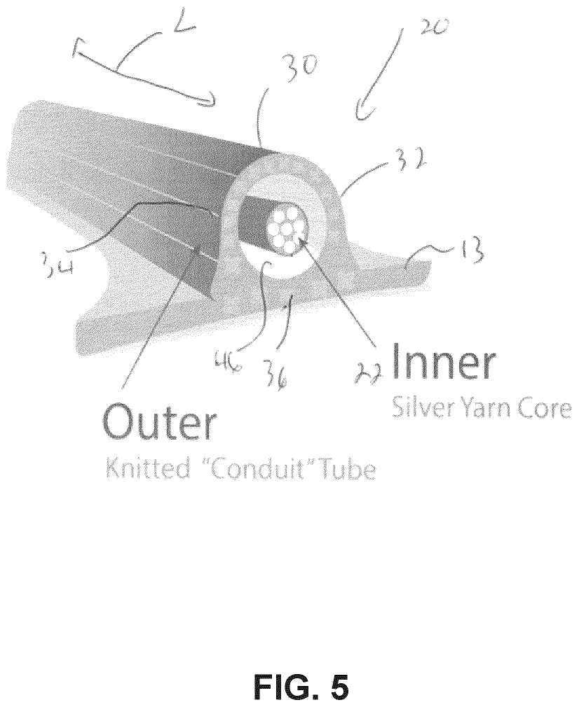

In terms of being connected 26, this can mean that, for example, the set of fibres 24a can contain or otherwise be interlaced with one or more of the fibres 24b (e.g. the fibre 24b is integral with/common to both the fabric layer of the body 13 on either side 10, 12 of the wall structure 28, and the wall structure 28 (one or more sides 30, 32, 34 as described below)—see FIG. 3). Alternatively, the fibre(s) 24a could be interlaced (i.e. connected 26) to the fibre(s) 24b via one or more intervening fibre(s) 24c interlacing the fibre(s) 24a with the fibre(s) 24b—see FIG. 5, such that the intervening fibre(s) 24c are each on one of the sides 10,12 but not both. This is compared to the fibre(s) 24b in the set of fibres 24a, as the connecting 26 mechanism, which extend from one side 10 to the other side 12 via the wall structure 28. Further, it is recognised that the term connected 26 can include both the presence of fibres 24b as well as fibres 24c, in combination. Accordingly, in terms of the connection 26 involving the connection fibres 24c, the pattern of interlacing between the fibres 24a,b,c can be knitting or waving, for example. As such, the connection 26 can be formed by interlacing the fibres 24c both with adjacent fibres 24b in the base fabric layer 13 and with adjacent fibres 24a in the wall structure 28. As such, the connection 26 can be formed by interlacing the fibre(s) 24b in the base fabric layer 13 (e.g. extending form one side 10 to the other side 12) with adjacent fibres 24a in the wall structure 28.

In any event, it is recognised that at least a portion of the fibres 24b in the wall structure 28 and/or the fibres 24c in the wall structure 28 are included as an interlaced component providing structural integrity of the fabric layer of the body 13, as the fibres 24b and/or 24c are incorporated (i.e. interlaced) into the wall structure 28 and the fabric layer of the body 13 at the same time of interlacing (e.g. weaving, knitting) of the textile computing platform 9 of the garment 11. In other words, removing the fibre(s) 24b,24c connecting 26 the fibres 24a to the fabric layer of the body 13 would negatively impact the structural integrity of the interlacing of the fibres 24b with one another in the fabric layer of the body 13, as there are fibre(s) 24b,24c common to both the base fabric layer of the body 13 and the wall structure 28.

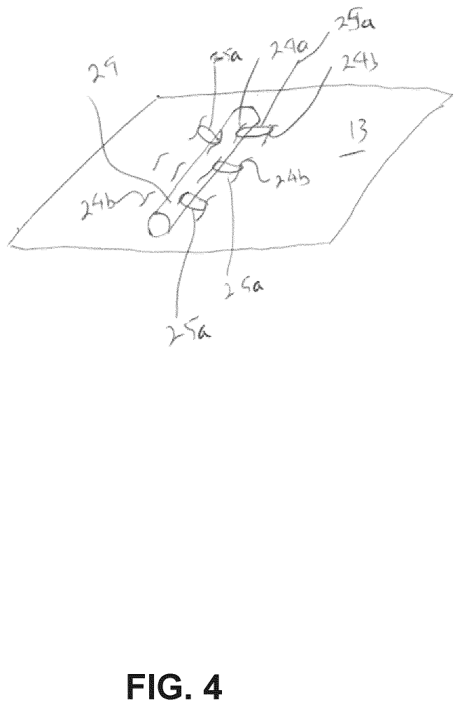

The connected 26 examples shown in FIG. 3 of fibre(s) 24b,c are differentiated from conventional embroidery such as that shown in FIG. 4, in that fibres 25a connecting an independent knit structure 29 to the base fabric layer 13 are simply contained/separate fibres to that of the interlaced fibres 24b of the fabric layer of the body 13 and the interlaced fibres 24a making up the independent knit structure 29 (e.g. at least of the sides 30, 32, 34), such that removal (e.g. severing i.e. breaking the connection 25a) of the fibres 25a (applied via embroidery techniques for example) from between independent knit structure 29 and the fabric layer of the body 13 would not result in destroying/compromising the structural integrity of the interlacing between the respective set of fibres 24a in the sides 30, 32, 34, and would not destroy/compromise the structural integrity of the interlacing between the fibres in the respective set of fibres 24b in the fabric layer of the body 13.

Thus, in terms of embroidery, the process of applying the fibres 25a in FIG. 4 can be performed after (e.g. separate from) the process of manufacturing (e.g. weaving, knitting) both individually the fabric layer of the body 13 and the independent knit structure 29, because separately applying the fibres 25a will not result in destroying and/or comprising the structural integrity of the interlacing. This separate process of embroidering, as shown in FIG. 4, is different from the simultaneous interlacing process of forming the fabric layer of the body 13 along with the interconnections 26 and the wall structure 28 containing the conductive fibre(s) 22 shown in FIG. 3.

In comparison to the embroidery example shown in FIG. 4, the set of fibres 24a,b,c shown in FIG. 3 may advantageously provide for a sharing of the structural integrity of the interlacing in the wall structure 28. In other words, severing or otherwise breaking or trying to remove any fibres (in the wall structure 28 and/or in the base fabric layer 13 adjacent to the wall structure 28) of a pair of the types of fibres 24a,b,c would result in compromising or otherwise impacting detrimentally the structural integrity of the interlaced fibres making up of the wall structure 28 and/or the adjacent base fabric layer 13.

For example, in one embodiment the base fibre(s) 24b are included with the wall fibre(s) 24a as the pair of fibre types interlaced with one another in the wall structure 28 so as to cooperatively provide for the structural integrity of the interlacing network of the fibres 24a,b making up the wall structure 28. Thus, any breaking/severing of fibre(s) 24a and/or 24b present in (and/or adjacent to) the wall structure 28 may compromise the structural integrity (e.g. unravelling of the wall structure 28 and/or the base fabric layer 13 adjacent to the wall structure 28), which would be undesirably facilitated in subsequent “wear and tear” (wearing and/or cleaning of the garment/textile 11) of the textile computing platform 9 (which contains the base fabric layer 13 and the wall structure(s) 28).

Because continued integrity/attachment of the wall structure 28 to the base fabric layer 13 is considered important, both in terms of providing structural integrity to the complete garment/textile, and providing insulative properties to conductive fibre 22, it is important that the selected pair of fibre 24a,b types continue to cooperate and maintain the structural integrity of both the wall structure 28 and the base fabric layer 13 in the vicinity of the base fabric layer 13.

In another example embodiment, the connection fibre(s) 24c are included with the wall fibre(s) 24a as the pair of fibre types interlaced with one another in the wall structure 28 so as to cooperatively provide for the structural integrity of the interlacing network of the fibres 24a,c making up the wall structure 28. That the connection fibre(s) 24c may at the same time be interlaced with the base fibre(s) 24b, thus contributing to the structural integrity of the fibre interlacing making up of the base fabric layer 13.

Therefore, any breaking/severing of fibre(s) 24a and/or 24c present in (and/or adjacent to) the wall structure 28 would compromise the structural integrity (e.g. unravelling of the wall structure 28 and/or the base fabric layer 13 adjacent to the wall structure 28), which would be undesirably facilitated in subsequent “wear and tear” (wearing and/or cleaning of the garment/textile 11) of the textile computing platform 9 (which contains the base fabric layer 13 and the wall structure(s) 28).

Because the continued integrity/attachment of the wall structure 28 to the base fabric layer 13 is considered important (e.g. in order to provide for the desired insulative properties for the conductive fibre 22), as well as the desired integrity of the base fabric layer 13 (e.g. providing the contextual structure of the complete garment/textile 11) being considered important, the ability of the selected pair of fibre 24a,c types to cooperate and maintain the structural integrity of both the wall structure 28 and the base fabric layer 13 in the vicinity of the base fabric layer 13 is important.

In another example embodiment, the connection fibre(s) 24c and the base fibre(s) 24b are included with the wall fibre(s) 24a as the pairs of fibre types interlaced with one another in the wall structure 28 so as to cooperatively provide for the structural integrity of the interlacing network of the fibres 24a,b,c making up the wall structure 28. It is also deemed that the connection fibre(s) 24c are at the same time also interlaced with the base fibre(s) 24b and thus also contribute to the structural integrity of the fibre interlacing making up of the base fabric layer 13. Thus, it is recognised that any breaking/severing of fibre(s) 24a, 24b and/or 24c present in (and/or adjacent to) the wall structure 28 would compromise the structural integrity (e.g. unravelling of the wall structure 28 and/or the base fabric layer 13 adjacent to the wall structure 28), which would be undesirably facilitated in subsequent “wear and tear” (wearing and/or cleaning of the garment/textile 11) of the textile computing platform 9 (i.e. containing the base fabric layer 13 and the wall structure(s) 28). As the desired continued integrity/attachment of the wall structure 28 to the base fabric layer 13 is considered important (e.g. in order to provide for the desired insulative properties for the conductive fibre 22), as well as the desired integrity of the base fabric layer 13 (e.g. providing the contextual structure of the complete garment/textile 11) is considered important, the ability of the selected pairs of fibre 24a,b,c types to cooperate and maintain the structural integrity of both the wall structure 28 and the base fabric layer 13 in the vicinity of the base fabric layer 13 is important.

FIGS. 3 and 5 depict an example embodiment in which the wall structure 28 comprises mainly the interlaced fibres 24a making up a first side 30, a second side 32 and a third side 34 to partially surround the conductive fibre(s) 22. A fourth side 36 of the wall structure 28 can be formed of the fabric layer of the body 13 including predominantly or completely the fibres 24b, thus providing for the insulative structure 20 having the four sides 30, 32, 34, 36 to completely encapsulate the conductive fibre(s) 22 along a length L of the fibre(s) 22.

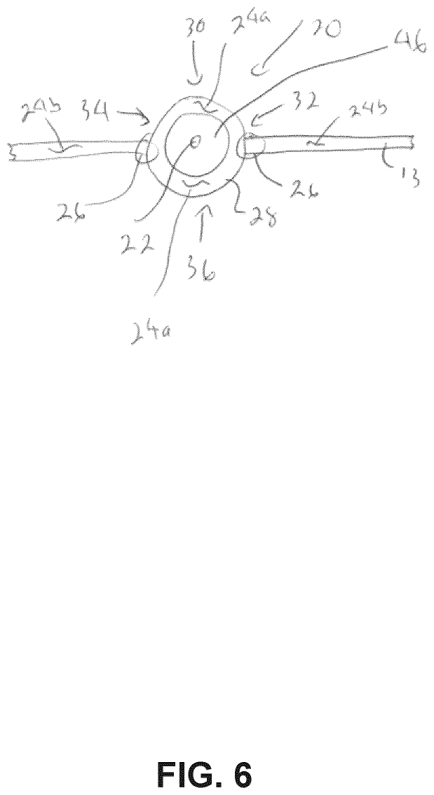

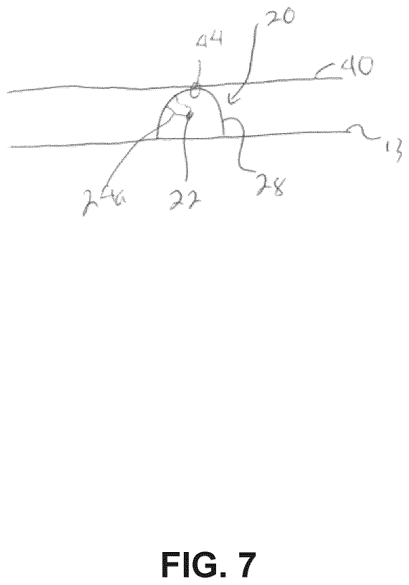

Alternatively, as shown in FIG. 6, a further example embodiment of the wall structure 28 comprises mainly the interlaced fibres 24a making up the first side 30, the second side 32, the third side 34 and the fourth side 36 to completely surround the conductive fibre(s) 22. In turn, one or more of the sides 30, 32, 34, 36 (e.g. two) of the wall structure 28 can be connected 26 to the fabric layer of the body 13 including predominantly or completely the fibres 24b, thus providing for the insulative structure 20 having the four sides 30, 32, 34, 36 to completely encapsulate the conductive fibre(s) 22 along a length L of the conductive fibre(s) 22. In this example, the fibres 24b of the fabric layer of the body 13 do not make up one of the sides 30, 32, 34, 36, other than where used (optionally) for the connections 26 of the wall structure 28 to the fabric layer of the body 13. In either case of FIG. 3 or 6, it is recognised that a cross sectional shape of the wall structure 28 (enclosing the conductive fibre(s) 22 in the cavity 46) can be comprised of sides 30, 32, 34, 36 being rectilinear (e.g. a quadrilateral shape). In either case of FIG. 3 or 7, it is recognised that a cross sectional shape of the wall structure 28 (enclosing the conductive fibre(s) 22 in the cavity 46) can be comprised of sides 30, 32, 34, 36 being arcuate (e.g. a circular shape). In either case of FIG. 3 or 6, it is recognised that a cross sectional shape of the wall structure 28 (enclosing the conductive fibre(s) 22 in the cavity 46) can be comprised of sides 30, 32, 34, 36 being a combination of arcuate and rectilinear.

Referring to FIG. 7, shown is an example garment 11 cross section incorporating the insulated conductor 20 having; the wall structure 28 (utilizing a portion of the fabric layer of the body 13), the conductive fibre(s) 22, and a cover fabric layer 40. The cover layer 40 can be used in the garment 11 in order to visually hide the wall structure 28 from observation of the garment wearer. Referring to FIG. 9, shown is a further example garment 11 cross section incorporating the insulated conductor 20 having; the wall structure 28 (utilizing a portion of the fabric layer of the body 13), the conductive fibre(s) 22, the fabric cover layer 40, and a second fabric cover layer 42. The cover layers 40,42 can be used in the garment 11 in order to visually hide the wall structure 28 from observation of the garment wearer.

Cover layer(s) 40, 42 may be unconnected, i.e. facilitating any relative movement between the cover layer(s) 40, 42 and the wall structure 28 and/or fabric layer of the body 13. Alternatively, cover layer(s) 40, 42 can be unconnected, such as by using adhesive and/or connecting fibres 44, i.e. inhibiting any relative movement between the cover layer(s) 40, 42 and the wall structure 28 and/or fabric layer of the body 13. Further, conductive fibre(s) 22 may be unconnected to any of the fibres 24a,b,c making up the wall structure 28, thereby facilitating relative movement between the sides 30, 32, 34, 36 of the wall structure 28 and the conductive fibre(s) 22. Further, in terms of the conductive fibre(s) 22, the conductive fibre(s) 22 can be connected (e.g. via any one or all of the fibre types 24a, 24b, 24c) to any of the fibres 24a,b,c making up the wall structure 28, thereby inhibiting relative movement between the sides 30, 32, 34, 36 of the wall structure 28 and the conductive fibre(s) 22.

The fibres 24a predominantly making up the wall structure 28 can be composed of hydrophilic material, or hydrophilic coated material, in order to inhibit penetration of moisture into the cavity 46 of the wall structure 28 containing the conductive fibre(s) 22. Further, it is recognized that the fibres 24a predominantly making up the wall structure 28 can be comprised of electrically insulative material in order to inhibit undesired transfer of electrical charge between the conductive fibre(s) 22 and the fibres 24b external (i.e. outside of the cavity 46) to the wall structure 28 (e.g. in the fabric layer of the body 13).

In some embodiments, the conductive fibre(s) 22 can be comprised of a conductive material which has the ability to generate and/or conduct heat and/or electricity via the application of a current (or generation of a current) through the conductive fibre(s) 22 (for example, as a sensory output/input of the wearer/user implemented by the corresponding application of the device 14,23). For example, the conductive fibre(s) 22 can be made of metal such as silver, stainless steel, copper, and/or aluminum. The non-conductive fibres 24a, 24b, 24c (which comprise portions of the body 13 that contain non-conductive fibres that are not segments in the conductive circuit 17 or sensors/actuators 18), can be selected from available synthetic fibers and yarns, such as polyester, nylon, polypropylene, or any suitable material or equivalent thereof), natural fiber and yarns (such as, cotton, wool, etc., and any equivalent thereof), a combination and/or permutation thereof, and each as required to obtain the desired properties of the final garment 11 or textile structure 9.

FIG. 14a depicts an accordion type structure 50 comprising a plurality of wall structures 28 adjacent to one another, as interposed in a section 52 between adjacent body 13 sections 54. The accordion type structure 50 includes the individual wall structures 28 and respective conductive fibre(s) 22 contained within each wall structure 28 along the length L, thereby forming one of the sensors 18 (see FIG. 3). As an example, the sensor 18 can be calibrated to measure the temperature of adjacent objects, e.g. garment/textile 11 wearer's body, external environment to the wearer and the garment/textile 11, measure temperature of the user's body 8 adjacent to the textile 11 (e.g. seat covering, sheet, etc.), etc. As described above, each wall structure 28 comprises fibres 24a interlaced with one another to form the wall structures 28 also interconnected 26 (i.e. interlaced) with the set of fibres 24b making up the surface layer of the body 13 of the textile garment 11 (i.e. adjacent sections 54). It is also recognised that the accordion type structure 50 can extend (e.g. from either one side or both sides-see FIGS. 5 and 6) from the body 13 of the garment 11. It is recognised that the adjacent wall structures 28 are also connected 26 to one another.

An advantage to the accordion type structure 50 is that the wall structures 28 provide for stretching in a lateral direction LAT (e.g. 90 degrees or other as desired) to the direction/length L of the wall structures 28, such that the respective conductive fibre(s) 22 in each of the wall structures 28 are inhibited from stretching in the L direction while the sensor 18 as a whole is facilitated to stretch and therefore move with the wearer of the garment 11 in the LAT direction. The ability of each of the wall structures 28 as a group in the accordion type structure 50 provides for the senor 18 to stretch along with the adjacent base body 13 sections 54 while at the same time inhibiting any stretch in the individual conductors 22.

For example, the cross sectional shape of the wall structures 28 in a pre-stretched configuration (e.g. relaxed state-see FIG. 14a) may be circular, while the cross sectional shape of the wall structures 28 in a stretched configuration (e.g. stretched state-see FIG. 14b) is elliptical or a distorted circular shape closer to an oval. In other words, a dimension D1 of the cross section (lateral to the length L) of the wall structure 28 may decrease in size from the relaxed state to the stretched state while a dimension D2 lateral to both D1 and the direction L may increase in size from the relaxed state to the stretched state, thus providing for the extendibility or stretch ability of the sensor 18 in the LAT direction while inhibiting any stretch/strain of the individual conductive fibre(s) 22 in the LAT direction.

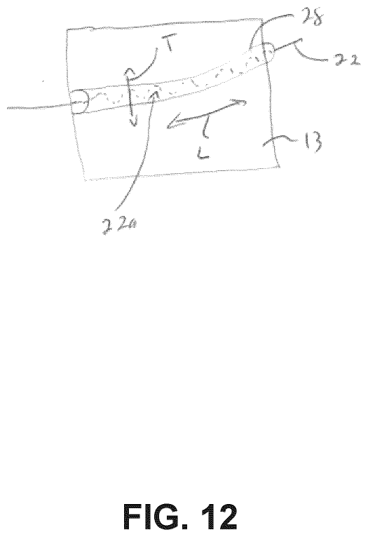

FIG. 12 depicts the wall structure 28 incorporated into a base fabric layer 13 as described above, i.e. involving the shared structural integrity of both the wall structure 28 interlacing and the base fabric layer 13 interlacing, using one or more pairs of fibre types incorporated in the interlacing of the wall structure 28, e.g. the pair of types of fibres 24a,b, the pair of types of fibres 24a,c, or the two pairs of types of fibres 24a,b and 24a,c (see FIG. 3). The conductive fibre(s) 22 positioned along the length of the wall structure 28 can be oriented in a serpentine fashion, i.e. the length of the conductive fibre(s) 22 within the wall structure 28 is greater that the length of the wall structure 28 itself. For example, the conductive fibre(s) 22 can contain alternating folds 22a in a direction transverse T to the length L of the wall structure 28. These alternating folds 22a can advantageously provide for stretching experienced by the base fabric layer 13 in the length L direction and/or in both the length L and transverse T directions as the garment/textile 11 is utilized by the user/wearer.

In some embodiments, one or more sensors 18 may be insulated by the accordion type structure 50, the individual conductors 22 (e.g. conductive fibre(s)) might not be interlaced with one another along the length L as the individual conductors are contained within their respective wall structures 28), as compared to the interlacing between the other fibres 24a, 24c used to make up the wall structures 28 themselves and with the adjacent set of body 13 fibres 24b in the sections 50. In some embodiments, conductors 22 are shielded or otherwise insulated from contact with one another along the respective lengths L of each of the adjacent wall structures 28, i.e. by the presence of the set of interlaced fibres 24a,c making up the sides 30, 32, 34, 36 of the wall structures 28 (see FIGS. 5,6). As such, the sides 30, 32, 34, 36 of the wall structures 28 form the cavity 46 in which the respective conductive fibre(s) 22 reside or are otherwise contained in order to shield them from moisture and/or electrical shorting with respect to the presence of water and/or other electrically conductive objects/bodies external to the wall structures 28.

In some embodiments, adjacent wall structures 28 (containing interlaced fibres 24a) may be connected 26 to one another, for example using connection fibres 24c (however, fibres 24b shared in both the wall structure 28 as well as in the adjacent body 13 section 54 could also be used as the connection 26, either alone or in combination with the connection fibres 24c).

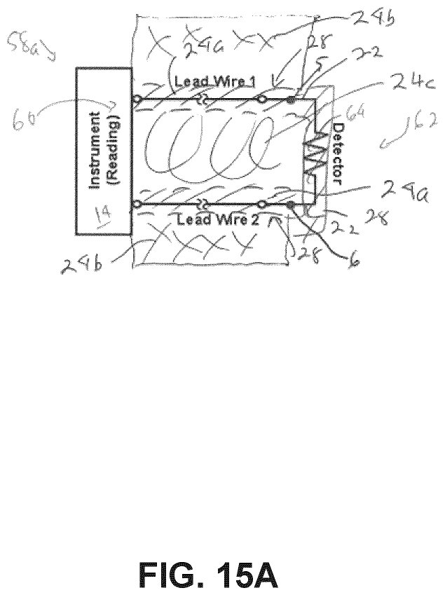

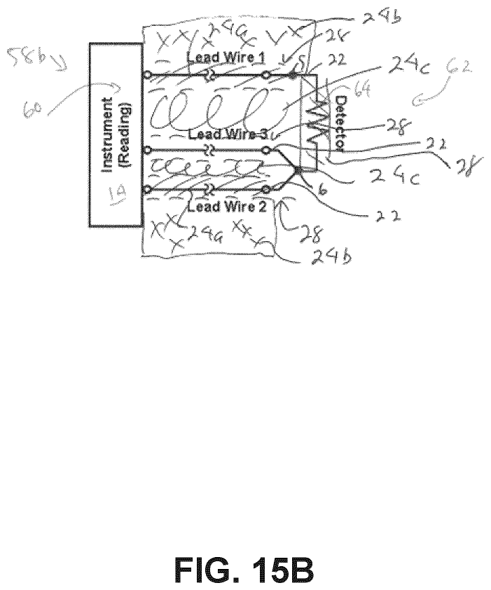

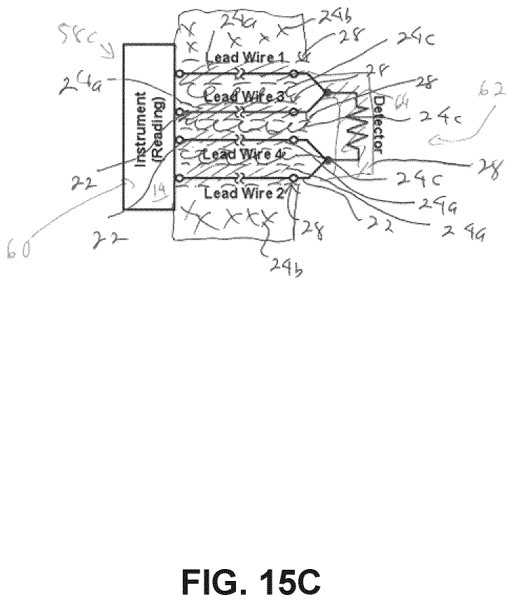

Example embodiments of sensor circuits 58a, 58b, 58c of the sensors 18 are depicted in FIGS. 15A-15C, including a 2-wire detection circuit in FIG. 15A, a 3-wire detection circuit in FIG. 15B, and a 4-wire RTD (Resistance Temperature Detector) temperature sensor circuit in FIG. 15C.

As depicted in FIGS. 15A-15C, each of sensor circuits 58a, 58b, 58c include a plurality of conductors 22 (e.g. 2, 3, and 4 conductors, respectively), each electrically connected at one end 60 to controller 14 and also connected to one or more conductor(s) 22 at the other end 62. As such, each end 60,62 are opposed to one another with respect to the length L (as shown in FIG. 5) of the wall structures 28. Accordingly, at end 62, at least a pair of the conductive fibres 22 are electrically connected to one another (e.g. via a detector 64 portion of the sensor circuit 58a, 58b, 58c-depicted as a resistor for the purposes of simplicity). At the other end 60, each of the conductors are electrically connected to the controller 14. It is recognised that each of the conductors 22 are positioned electrically parallel to one another in the sensor circuit 58a, 58b, 58c between the endpoints 60,62. Further, the conductors 22 might only be electrically connected to one another at the one end 62 and at the other end 60 to the common controller 14. As such, along the length L, the conductive fibres 22 remain electrically insulated from one another in view of the adjacent wall structures 28 making up the accordion type structure 50. It should be noted that in some embodiments, although detector 64 is depicted as a resistive element, this may be a representation of the resistive value(s) of the conductive fibres 22 in a region of the conductive fibres 22 specified as the temperature sensor 18 (e.g. as shown in FIG. 2, in which the remainder or second portion of the conductive fibre(s) 22 acts as a conductive pathway(s) 17).

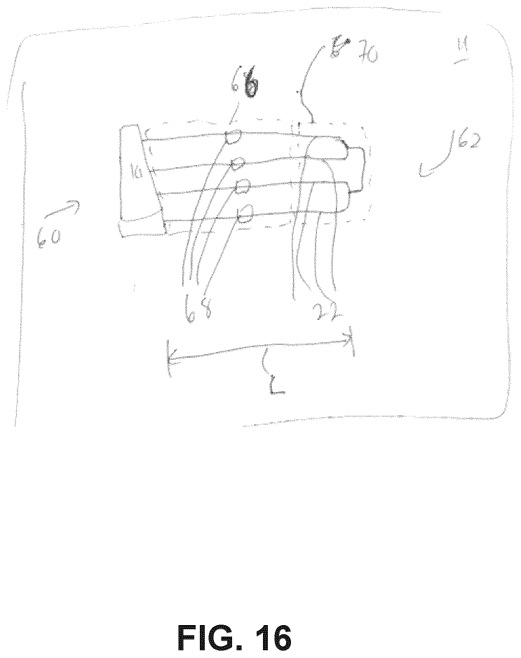

FIG. 16 depicts different portions of the conductive fibres 22 acting as a sensor 18 portion and a pathway 17 portion. In this example embodiment, the 4-wire conductive fibre 22 implementation is shown by way of example only and 2- or 3-wire techniques are also contemplated.

For the purposes of simplicity, the wall structures 28 (see FIG. 15C) have been omitted from FIG. 16. As noted, the portion 66 (i.e. pathway portion 66) of the plurality of conductive fibres 22 along the length L may provide for electrical conduction of electrical signals 68 between the portion 70 of the plurality of conductive fibres 22 along length L used to sense temperature of an adjacent body part of the wearer of the garment 11 incorporating the sensor 18 (see FIGS. 1, 2), as received and interpreted by the controller 14.

It will be appreciated that the resistance of the conductive fibres 22 may be measured in order to determine a temperature value of the wearer (and/or environment) adjacent to the portion 70 of the conductive fibres. This temperature value may be correlated (as interpreted by the controller 14) to the amount of resistivity of the conductive fibres 22. For example, as the temperature increases, the resistivity of the conductive fibres 22 as measured by the controller 14 via the signals 68 may increase. Resistivity values may be measured, for example, by applying a known current to conductive fibres 22 and measuring a voltage drop at, for example, different pins of a circuit element (e.g. a programmable gate array). Using Ohm's law, the resistivity (or change in resistivity relative to known values) of the conductive fibres 22 may be determined.

In some embodiments, the resistivity of the portion 70 may be correlated to temperature via the applied voltage across the circuit 58a, 58b, 58c. It is recognised that the resistivity of a conductor increases with temperature. In the case of copper/stainless steel/silver, the relationship between resistivity and temperature is approximately linear over a wide range of temperatures. For other materials, using a relationship based on power rather than resistivity may be more suitable and/or accurate. Therefore, it is recognised that resistivity of a conductor increases with temperature and as such the resistivity of the portion 70 (e.g. detector 64 portion) is measured via the pathways 17 in connection with the controller 14.

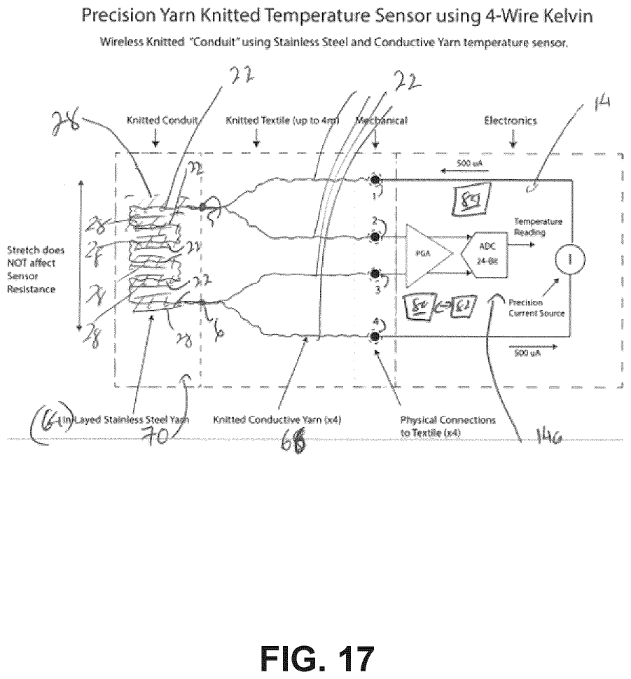

FIG. 17 depicts an example embodiment of the insulated conductor 20 having the wall structure 28 around the multiple conductive fibres 22 in the sensor portion 70 (e.g. detector 64 portion). In some embodiments, the resistivity of the conductive fibres 22 in the sensor portion 70 (e.g. detector portion or first portion 64) may be greater than the resistivity of the conductive fibres 22 in the pathway portion 66 (e.g. second portion 66) between the detector portion 64 and the controller 14.

Therefore, the conductive fibres in the pathway portion 66 may be connected at one end to the physical connectors 1, 2, 3, 4 (as an electrical interface to the electronics of the controller 14) and at the other end 5,6 to the detector portion 64. In some embodiments, the difference in resistivity in the conductive fibres 22 in the different (or first and second) portions 66, 70 can be used to inhibit or reduce the impact or influence of the resistance of the conductive fibres 22 in the pathway portion 66 relative to the resistance of the conductive fibres 22 in the second portion 70. Thus, determining the temperature of the area adjacent to second portion 70 may have enhanced accuracy by reducing the influence of the resistivity of the conductive fibres in first portion 66, thus increasing the sensitivity of the temperature detection systems in second portion 70.

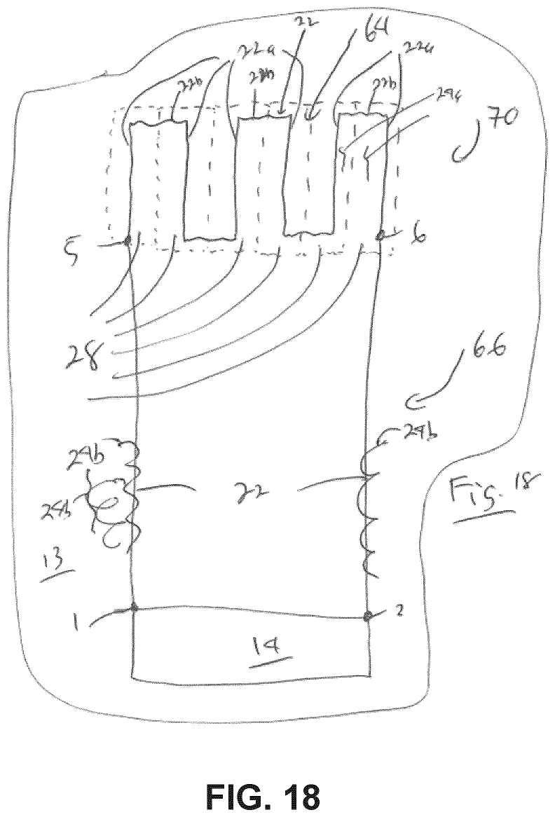

FIG. 18 depicts an example embodiment in which the detector portion 64 (with multiple conductive fibres 22 side by side) has a respective wall structure 28 (in ghosted view) adjacent to one another for the multiple conductive fibres 22 therein. While in this embodiment the detector portion 64 has respective wall structures, the conductive fibres 22 in the pathway portion 66 are not contained within wall structures 28. Therefore, the conductive fibres 22 in the pathway portion 66 are not insulated by wall structures 28 and can be directly interlaced into the body fibres 24b of the base fabric layer 13 (see FIG. 3). Such a configuration may be advantageous in the sense that a detector portion 64 may be connected in virtually any location of a garment through an electrical connection to a pathway portion 66.

In the example embodiment depicted in FIG. 18, the electrical resistivity of the conductive fibres 22 in the pathway portion 66 may be less than the resistivity of the conductive fibres 22 in the detector portion 64. For example, conductive fibres 22 in the detector portion 64 may be made of a different material than conductive fibres 22 in the pathway portion 64. In another example, conductive fibres 22 in different portions 66, 70 may have different cross-sectional areas or thicknesses, which would result in a different incremental and total resistance for the conductive fibres 22 in each portion 66, 70.

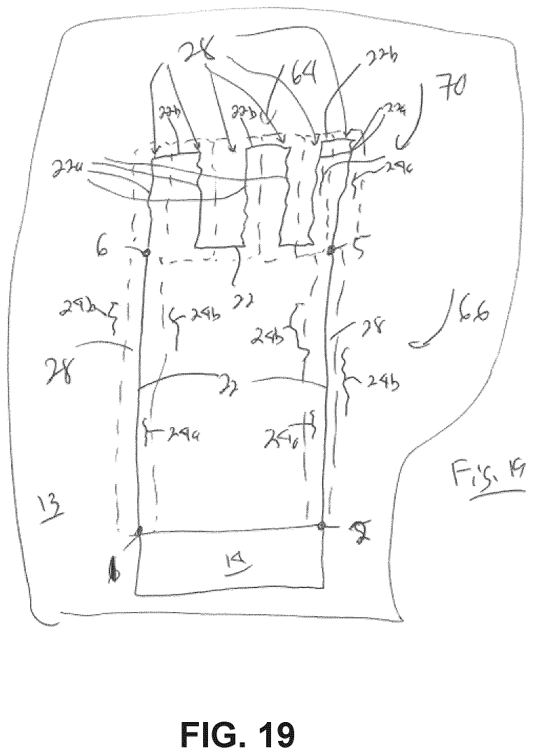

FIG. 19 depicts an example embodiment in which the detector portion 64 (with multiple conductive fibres 22 side by side) has a respective wall structure 28 (in ghosted view) adjacent to one another for the multiple conductive fibres 22 therein. Contrasting with the embodiment shown in FIG. 18, in FIG. 19 the conductive fibres 22 in the pathway portion 66 are also within wall structures 28 and thus are also insulated by their wall structures 28 and thus are not directly interlaced into the body fibres 24b of the base fabric layer 13 (see FIG. 3).

In the example depicted in FIG. 19, the resistivity of the conductive fibres 22 in the pathway portion 66 may be lower than the resistivity of the conductive fibres 22 in the detector portion 64. This may be accomplished by, for example, selecting different materials having different incremental resistances for the conductive fibres 22 in the different portions 66, 70, and/or using conductive fibres 22 which have different in cross-sectional areas or thicknesses in the different portions 66, 70.

The example embodiments shown in FIGS. 18 and 19 depict multiple segments 22a of the conductive fibre(s) 22 adjacent to one another in the detector portion 64. These segments 22a each run along the length L of their respective wall structure 28 (see FIG. 14a). Segments 22b of the conductive fibre(s) 22 are depicted as interconnecting the various segments 22a. The segments 22b are positioned transverse to the lengths L of the wall structures 28 for the segments 22a, however these segments 22b can also be contained in their own wall structures 28 running transverse (i.e. between adjacent wall structures 28 to the wall structures 28 for the segments 22a). In this manner, for example, the conductive fibre(s) 22 made up of multiple segments 22a,b may be insulated within their respective wall structures 28 adjacent to one another.

Returning to FIG. 17, a temperature detection system may include a current source 14a used to apply a constant or substantially constant current (I) through outer connectors 1, 4. A voltage drop may be measured across the inner connectors 2, 3, for example. Using Ohm's law, V=IR, controller 14 can determine the resistance of the detector portion 64. As shown in FIG. 17, the current source 14a, in combination with a computer processor 80 and memory 82, can be used to correlate measured resistance with corresponding temperature (e.g. via a stored correlation table), and thus output a detected temperature. In some embodiments, the detected temperature is reported to the operator of the controller 14.

In some embodiments, current source 14a may require a power source 84 for applying the current I to the connectors 1,4. Each knitted conduit 28 may carry an individual conductive yarn strand 22 in the length direction to the location of the temperature sensor (e.g. stainless steel yarns in the detector portion 64). At each end 5, 6, two of the conductive yarn strands 22 in the pathway portion 66 may be joined together along with one end of the yarn 22. The same is repeated at the other end 5, 6. This depicted connection of two conductive yarn strands connected to end 5 and two conductive yarn strands connected to end 6 forms the 4-wire temperature sensor.

In some embodiments, ends 5, 6 may be knitted connection pads manufactured in accordance with systems and methods described in U.S. Provisional Patent Application No. 62/949,859, filed Dec. 18, 2019, the entire contents of which are incorporated by reference. For example, ends 5, 6 may be manufactured by applying a weld at a junction where two or more conductive fibres or paths meet to create a bond between electrical paths, placing an electronic device at a location where a terminal of the electronic device is proximate the end of a given conductive path, and applying a weld at the end of the given conductive path to create a further bond, possibly through use of high-frequency ultrasonic acoustic vibration during welding.

In some embodiments, a precision current source 14a generating a constant current may be used to measure the resistance using a PGA (programmable Gain Amplifier) and an ADC (analog to digital converter) of the electronics 14a. In some embodiments, the current is 500 uA. In some embodiments, the ADC is a 24-bit ADC. In some embodiments, the calculated resistance can be converted to a voltage and then translated to temperature by the electronics 14a. In some embodiments, calibration may not be necessary, as the conductive fibres 22 in the pathway portion are controlled by length upon interlacing or layout within their own wall structure(s) 28. As noted above, the conductive segments 22a, 22b may then be in-layered (in their respective wall structures 28) transversely to provide the “accordion” benefit of the structure. This is advantageous, as it may inhibit the conductive segments 22a, 22b from stretching while allowing the base fabric layer 13 to have significant stretch during active use of the garment/textile 11.

As noted above, it is desirable for smart textiles to make efficient use of materials in order to lower manufacturing costs. In some embodiments, a temperature sensor may also act as a heating element.

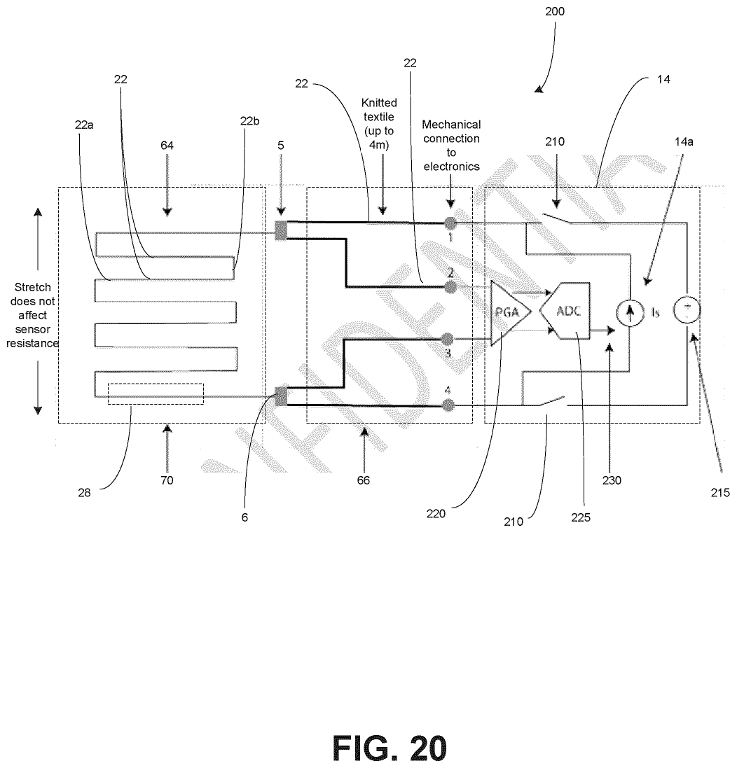

FIG. 20 is a block diagram illustrating components of an example fibre-based temperature sensing and heating system 200. As depicted, fibre-based temperature sensing and heating system 200 includes a detecting portion 64 or first portion 70, a pathway portion 66 or second portion, and a controller 14.

In some embodiments, first portion 70 is electrically connected to second portion 66 via one or more electrical connections 5, 6. In some embodiments, connections 5, 6 are knitted connection pads. In some embodiments, ends 5, 6 may be knitted connection pads manufactured in accordance with systems and methods described in U.S. Provisional Patent Application No. 62/949,859, filed Dec. 18, 2019, the entire contents of which are incorporated by reference. For example, ends 5, 6 may be manufactured by applying a weld at a junction where two or more conductive fibres or paths meet to create a bond between electrical paths, placing an electronic device at a location where a terminal of the electronic device is proximate the end of a given conductive path, and applying a weld at the end of the given conductive path to create a further bond, possibly through use of high-frequency ultrasonic acoustic vibration during welding.

In some embodiments, conductive fibres 22 in first 70 and/or second portion 66 may be insulated via wall structures 28. In some embodiments, detecting portion 64 includes conductive yarn 22 which is directly knitted into said textile 13. In some embodiments, detecting portion 64 may include conductive yarn 22 which is inlayed to said textile 13 using a flatbed knitting machine.

As depicted, controller 14 includes a temperature sensing circuit and a heating circuit. The heating circuit may include a power source 215 connected to connections 1, 4 via switching elements 210. In some embodiments, power source 215 may be a DC battery, an AC power source, or any suitable voltage source operable to apply an electrical current through detecting portion 64 which in turn causes heat to be dissipated in an area adjacent to detecting portion 64. In some embodiments, switching element 210 may be a switch, a thyristor, a solid state switch such as a transistor, or any other suitable electronic switching element. The temperature sensing circuit may include a programmable gain amplifier (PGA) 220, an analog to digital converter (ADC) 225, and current source 14a. In some embodiments, current source 14a provides 500 uA of current.

In some embodiments, system 200 is operable to use detecting portion 64 as both a temperature sensing element, and as a heating element. In some embodiments, system 200 is operable to switch between a heating mode and a temperature sensing mode. Switching between temperature sensing mode and heating mode may be accomplished by selectively opening or closing switching elements 210.

For example, when switching elements 210 are open, system 200 may function in accordance with other embodiments described herein, and particularly in a manner similar to the embodiment described in FIG. 17. However, it will be appreciated that many variations in configuration in accordance with other temperature sensing systems described herein (e.g. embodiments described in FIGS. 15A-15C and 16-19) are contemplated. FIG. 20 is not intended to be treated as limiting system 200 only to the particular circuit configuration shown and is merely one example configuration.

When switching elements 210 are closed, power source 215 becomes electrically connected to connection points 1, 4. Power source 215, when connected to connection points 1, 4 is thereby enabled to cause an electric current to flow through conductive fibres 22 and cause heat to be dissipated in detecting portion 64.

It will be appreciated that the amount of heat dissipated in any particular section of conductive fibre 22 will depend on the resistance of the conductive fibre. Therefore, in some embodiments, conductive fibres 22 in pathway portion 66 may be selected to have a lower electrical resistance than conductive fibres 22 in detecting portion 64. This may be accomplished, for example, by conductive fibres 22 in pathway portion 66 being selected to have a thickness which is greater than conductive fibres 22 in detecting portion 64. In some embodiments, conductive fibres 22 in pathway portion 66 may be made from a material which has lower electrical resistance than the material used for conductive fibres 22 in detecting portion 64. Having conductive fibres 22 in detecting portion 64 with a higher overall resistance than conductive fibres 22 in pathway portion 66 may improve the efficiency of operation of system 200.

Although FIG. 20 illustrates switching elements which serve only to connect (when closed) or disconnect (when opened) power source 215, it is contemplated that switching elements In some embodiments, switching elements 210 may be configured instead to alternate between connecting one of current source 14a or power source 215 to connections 1, 4.

In some embodiments, when power source 215 is connected to connections 1, 4, temperature sensing is not performed by system 200. In some embodiments, temperature sensing is performed by system 200 when current source 14a is connected to connections 1, 4. In some embodiments, temperature sensing is performed by system 200 only when current source 14a is connected and power source 215 is disconnected from connections 1, 4.

In some embodiments, controller 14 is configured to activate or toggle switching elements 210 in accordance with a predefined pattern. In some embodiments, the predefined pattern may be a periodic opening and closing with a defined period. In some embodiments, the predefined pattern may be a duty cycle. In some embodiments, the duty cycle may include the power source 215 being connected for 900 milliseconds and disconnected for 100 milliseconds (as well as temperature sensing taking place for that same 100 millisecond time period). It will be appreciated that other times and lengths for said duty cycle may be selected as appropriate for a particular application. In some embodiments, the duty cycle is implemented using pulse width modulation (PWM). In some embodiments, the PWM has a frequency of 1 kHz.

In some embodiments, controller 14 may obtain multiple temperature readings 230 during the 100 millisecond (or other) period in which temperature sensing is performed. In some embodiments, controller 14 may compute an average temperature based on said one or more temperature readings obtained from ADC 230 based on voltage inputs from PGA 220.

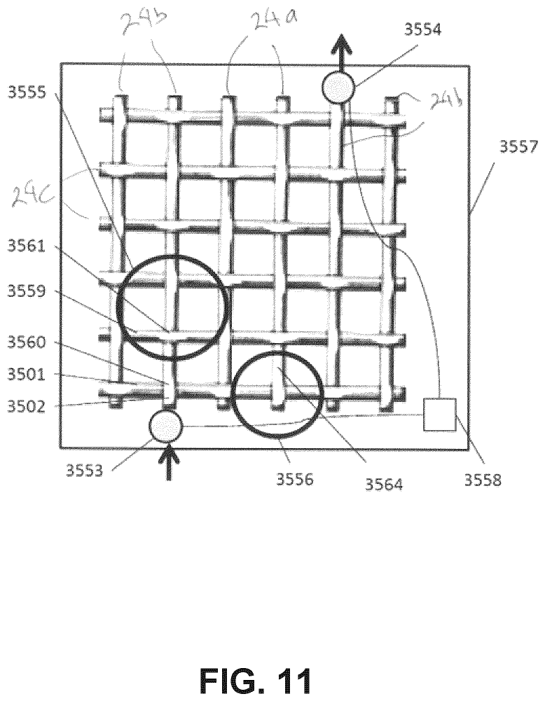

Referring to FIGS. 2, 9, 10 and 11, in one example embodiment, knitting can be used to integrate different sections of the textile (i.e. body 13 fibres 24b incorporating fibres of the sensors/actuators 18) into a common layer (e.g. having conductive pathway(s) 17 and non-conductive sections). Knitting comprises creating multiple loops of fibre or yarn, called stitches, in a line or tube. In this manner, the fibre or yarn in knitted fabrics follows a meandering path (e.g. a course), forming loops above and below the mean path of the yarn. These meandering loops can be easily stretched in different directions. Consecutive rows of loops can be attached using interlocking loops of fibre or yarn. As each row progresses, a newly created loop of fibre or yarn is pulled through one or more loops of fibre or yarn from a prior row. For example as shown in FIG. 9, warp knitting techniques can be used to integrate different sections of the textile (i.e. body 13 fibres 24b incorporating fibres of the sensors/actuators 18) into a common layer (e.g. having conductive pathway(s) and non-conductive sections). As shown in FIG. 11, weaving can be a further interlacing method of forming a textile in which two distinct sets of yarns or fibres are interlaced at transverse to one another (e.g. right angles) to form a textile.

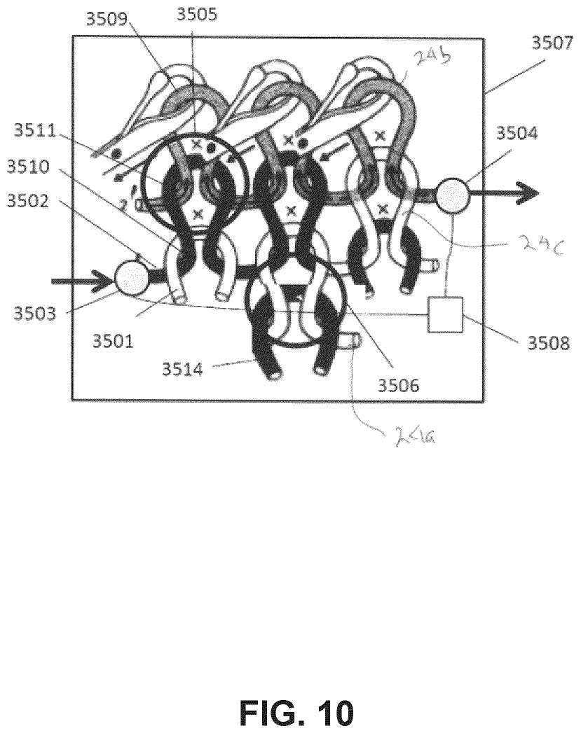

For example, FIG. 10 shows an exemplary knitted configuration of a network of electrically conductive fibres 3505 in, for example, a segment of an electrically conductive circuit 17 and/or sensor/actuator 18 (see FIG. 1). In this embodiment, an electric signal (e.g. current) is transmitted to conductive fibre 3502 from a power source (not shown) through a first connector 3505, as controlled by a controller 3508 (e.g. controller 14). The electric signal is transmitted along the electric pathway along conductive fibre 3502 past non-conductive fibre 3501 at junction point 3510. The electric signal is not propagated into non-conductive fibre 3501 at junction point 3510 because non-conductive fibre 3501 cannot conduct electricity. Junction point 3510 can refer to any point where adjacent conductive fibres and non-conductive fibres are contacting each other (e.g. touching). In the embodiment shown in FIG. 10, non-conductive fibre 3501 and conductive fibre 3502 are shown as being interlaced by being knitted together. Knitting is only one exemplary embodiment of interlacing adjacent conductive and non-conductive fibres. It should be noted that non-conductive fibres forming non-conductive network 3506 can be interlaced (e.g. by knitting, etc.). Non-conductive network 3506 can comprise non-conductive fibres (e.g. 3501) and conductive fibres (e.g. 3514) where the conductive fibre 3514 is electrically connected to conductive fibres transmitting the electric signal (e.g. 3502). For example, the interlacing method of the fibres in FIG. 10 can be referred to as weft knitting.

In the embodiment shown in FIG. 10, the electric signal continues to be transmitted from junction point 3510 along conductive fibre 3502 until it reaches connection point 3511. Here, the electric signal propagates laterally (e.g. transverse) from conductive fibre 3502 into conductive fibre 3509 because conductive fibre 3509 can conduct electricity. Connection point 3511 can refer to any point where adjacent conductive fibres (e.g. 3502 and 3509) are contacting each other (e.g. touching). In the embodiment shown in FIG. 10, conductive fibre 3502 and conductive fibre 3509 are shown as being interlaced by being knitted together. Again, knitting is only one exemplary embodiment of interlacing adjacent conductive fibres. The electric signal continues to be transmitted from connection point 3511 along the electric pathway to connector 3504. At least one fibre of network 3505 is attached to connector 3504 to transmit the electric signal from the electric pathway (e.g. network 3505) to connector 3504. Connector 3504 is connected to a power source (not shown) to complete the electric circuit.

FIG. 11 shows an exemplary woven configuration of a network of electrically conductive fibres 3555. In this embodiment, an electric signal (e.g. current) is transmitted to conductive fibre 3552 from a power source (not shown) through a first connector 3555, as controlled by a controller 3558 (e.g. controller 14). The electric signal is transmitted along the electric pathway along conductive fibre 3552 past non-conductive fibre 3551 at junction point 3560. The electric signal is not propagated into non-conductive fibre 3551 at junction point 3560 because non-conductive fibre 3551 cannot conduct electricity. Junction point 3560 can refer to any point where adjacent conductive fibres and non-conductive fibres are contacting each other (e.g. touching). In the embodiment shown in FIG. 20, non-conductive fibre 3551 and conductive fibre 3502 are shown as being interlaced by being woven together. Weaving is only one exemplary embodiment of interlacing adjacent conductive and non-conductive fibres. It should be noted that non-conductive fibres forming non-conductive network 3556 are also interlaced (e.g. by weaving, etc.). Non-conductive network 3556 can comprise non-conductive fibres (e.g. 3551 and 3564) and can also comprise conductive fibres that are not electrically connected to conductive fibres transmitting the electric signal. The electric signal continues to be transmitted from junction point 3560 along conductive fibre 3502 until it reaches connection point 3561. Here, the electric signal propagates laterally (e.g. transverse) from conductive fibre 3552 into conductive fibre 3559 because conductive fibre 3559 can conduct electricity. Connection point 3561 can refer to any point where adjacent conductive fibres (e.g. 3552 and 3559) are contacting each other (e.g. touching). In the embodiment shown in FIG. 11, conductive fibre 3552 and conductive fibre 3559 are shown as being interlaced by being woven together. The electric signal continues to be transmitted from connection point 3561 along the electric pathway through a plurality of connection points 3561 to connector 3554. At least one conductive fibre of network 3555 is attached to connector 3554 to transmit the electric signal from the electric pathway (e.g. network 3555) to connector 3554. Connector 3554 is connected to a power source (not shown) to complete the electric circuit. Again, weaving is only one exemplary embodiment of interlacing adjacent conductive fibres, such as fibres 24a,b,c as shown in demonstrating the interlacing technique of weaving the conduit 20 containing the fibres 24a as connected to the body 13 fibres 24b via connecting fibres 24c.

It is recognised that in general, a knit fabric is made up of one or more fibres formed into a series of loops that create rows and columns of vertically and horizontally interconnected stitches. A vertical column of stitches is called a wale, and a horizontal row of stitches is called a course.

In view of FIGS. 3 and 9, the interlacing of the fibres 24a, 24b, 24c (optional) making the insulated conductor 20 in combination with the fabric layer of the body 13 can be provided using knitting as the interlacing method via warp knitting (describing the direction in which the fabric is produced), also referred to as flat knitting, which is a family of knitting methods in which the fibres 24a, 24b, 24c zigzag along the length of the fabric (the combination of the wall structure 28 with the body 13), i.e. following adjacent columns, or wales, of knitting, rather than a single row (also referred to as weft knitting). A warp knit is made with multiple parallel fibres that are simultaneously looped vertically (at the same time) to form the fabric. A warp knit is typically produced on a flat-bed knitting machine, which delivers flat yardage. For example, a “Flat” or Vee Bed knitting machine can consists of 2 flat needle beds arranged in an upside-down “V” formation. These needle beds can be up to 2.5 metres wide. A carriage, also known as a Cambox or Head, moves backwards and forwards across these needle beds, working the needles to selectively, knit, tuck or transfer stitches. The flat knitting machine can provide for complex stitch designs, shaped knitting and precise width adjustment. Again as the name infers, flat bed are horizontal needle beds where the yarn is moved across the vee shaped needle bed within feeders.

For comparison, knitting across the width of the fabric is called weft knitting (also referred to as circular knitting), for example see FIG. 10. Contrary to warp knitting, weft knitting (describing the direction in which the fabric is produced) is such fabric made with a single yarn that's looped to create horizontal rows, or courses, with each row built on the previous row. A weft knits is typically performed on a circular knitting machine, which produces a tube of fabric. For example, circular, as the name infers, is knitting in the round. Here the yarn fed directly (up to 32 separate yarns) into the needle bed that spins around in one direction and creates a tube on fabric through the centre. Simultaneous construction of the desired wall structure 28, in combination with the fabric layer of the body 13, cannot be performed as desired using circular knitting techniques. Accordingly, for interlacing done as knitting, warp knitting is needed to simultaneous construct the desired wall structure 28 in combination with the fabric layer of the body 13.

Further, interlacing of the fibres 24a, 24b, 24c (optional) making up the insulated conductor 20 in combination with the fabric layer of the body 13 can be provided using weaving as the interlacing method, which is composed of a series of warp (lengthwise) fibres interlaced with a series of weft (crosswise) fibres. As such, in a woven fabric, the terms warp and weft refer to the direction of the two sets of fibres making up the fabric.

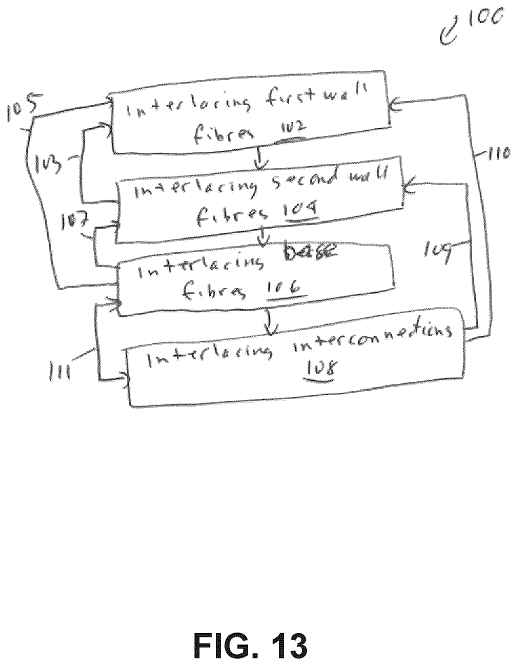

FIG. 13 is a flow chart depicting an example method 100 for manufacturing an insulated conductor 22 integrated into a base fabric layer 13 for a textile 11, the method comprising: interlacing 102 a set of first wall fibres 24a with one another to form a first wall structure 28 defining a cavity 46 along a length L, the set of first wall fibres 24a comprising nonconductive material; positioning at least one conductive first fibre 22 running along the length L within the cavity 46, such that the set of first wall fibres of the first wall structure 28 encloses the at least one conductive first fibre 22 in order to electrically insulate the at least one conductive first fibre 22 from an environment along the length L external to the cavity 46; interlacing 104 a set of second wall fibres 24a with one another to form a second wall structure 28 defining a cavity 46 along a length L, the set of second wall fibres 24a comprising nonconductive material; positioning 104 at least one conductive second fibre 22 running along the length L within the cavity 46, such that the set of second wall fibres of the second wall structure 28 encloses the at least one conductive second fibre 22 in order to electrically insulate the at least one conductive second fibre 22 from an environment along the length L external to the cavity 46; interlacing 106 a set of base fibres 24b with one another to form the base fabric layer 13; and interlacing 108 a first fibred interconnection 26 and a second fibred interconnection 26, the base fabric layer 13 having a first side 10 adjacent with the first fibred interconnection 26 to the first wall structure 28 and a second side 12 adjacent with the second fibered interconnection 26 to the second wall structure 28, the first fibered interconnection 26 opposed to the second fibred interconnection 26, the first side and the second side forming a surface of the base fabric layer 13 such that the first and second wall structures 28 are interposed between the first 10 and second 12 sides, the first fibred interconnection 26 and the second fibred interconnection 26 respectively forming part of a structural fabric integrity of the set of first and second wall 24a fibres and a structural fabric integrity of the set of base 24b fibres; wherein subsequent damage to fibres of at least one of the first fibred interconnection 26 or the second fibred interconnection 26 results in destruction of the structural fabric integrity of the set of first/second wall fibres 24a and the structural fabric integrity of the set of base fibres 24b.

Of course, the above described embodiments are intended to be illustrative only and in no way limiting. The described embodiments are susceptible to many modifications of form, arrangement of parts, details and order of operation. Moreover, combinations of various embodiments are contemplated and within the scope of the invention. For example, it is contemplated that different embodiments of temperature sensing circuits described herein (with potentially different insulation and wiring configurations) may be combined with different embodiments of heating circuits described herein. The invention is intended to encompass all such modification within its scope, as defined by the claims.

What is claimed is:

1. A system for a fibre-based temperature sensor and heater integrated into a base fabric layer for a textile, the system comprising:
a first portion of conductive fibre electrically connected to a second portion of conductive fibre;
a heating circuit for heating an area adjacent to the first portion of conductive fibre, the heating circuit comprising a power source selectively connected to said second portion of conductive fibre via one or more switching elements;
a controller configured to measure an electrical resistivity of the first portion of conductive fibre to determine a temperature associated with an area adjacent to said first portion of conductive fibre,
said controller further configured to selectively activate said one or more switching elements to cause said power source to heat said area adjacent to said first section of conductive fibre.

2. The system of claim 1, wherein the first portion of conductive fibre has a first thickness which is less than a second thickness of the second portion of conductive fibre.

3. The system of claim 1, wherein said controller is configured to activate said one or more switching elements in accordance with a duty cycle.

4. The system of claim 3, wherein said duty cycle comprises heating said area adjacent to said first portion for 900 ms and determining said temperature associated with said area adjacent to said first portion for 100 ms.

5. The system of claim 1, wherein causing said power source to heat said area adjacent to said first portion of conductive fibre comprises electrically connecting said power source to said first portion of conductive fibre.

6. The system of claim 1, wherein said controller is configured to activate said one or more switching elements using pulse width modulation.

7. The system of claim 6, wherein said pulse width modulation has a frequency of 1 kHz.

8. The system of claim 1, further comprising a current source configured to apply an electric current to said first portion of conductive fibre.

9. The system of claim 1, wherein determining said temperature associated with an area adjacent to said first portion of conductive fibre comprises determining an electrical resistance of said first portion of conductive fibre and obtaining a temperature based on said resistance.

10. The system of claim 9, wherein obtaining said temperature comprises inputting said resistance value to an analog to digital converter having stored thereon a mapping of resistance values to temperature values.

11. The system of claim 1, wherein said first portion of conductive fibre is electrically connected to said second portion of conductive fibre via a knitted connection pad connecting 1 conductive fibre from said first portion of conductive fibre to 2 conductive fibres from said second portion of conductive fibre.

12. The system of claim 1, wherein said first portion of conductive fibre is directly knitted into said base fabric layer.

13. A method of using a fibre-based temperature sensor and heater integrated into a base fabric layer for a textile, the method comprising:
heating a first portion of conductive fibre for a first time duration using a power source;
disconnecting said power source from said first portion of conductive fibre for a second time duration;
measuring, during said second time duration, a resistance of said first portion of conductive fibre;
determining, based on said resistance, a temperature of an area adjacent to said first portion of conductive fibre.

14. The method of claim 13, wherein the first time duration is 900 ms and the second time duration is 100 ms.

15. The method of claim 13, wherein disconnecting said power source from said first portion of conductive fibre comprises activating a switching element by a controller.

16. The method of claim 13, wherein said first portion of conductive fibre is directly knitted into said base fabric layer of said textile.

17. The method of claim 13, wherein said power source is connected to said first portion of conductive fibre via a second portion of conductive fibre, wherein said second portion of conductive fibre has an electrical resistance which is less than an electrical resistance of said first portion of conductive fibre.
